(19) United States
(12) Patent Application Publication
(10) Pub. No.: US 2023/0387992 A1
(43) Pub. Date: Nov. 30, 2023

(54) METHODS AND APPARATUSES FOR BEAM REPORTING FOR MULTIPLE TRANSMISSION/RECEPTION POINTS

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 18/234,064

(22) Filed: Aug. 15, 2023

Related U.S. Application Data
(63) Continuation of application No. PCT/IB2022/052071, filed on Mar. 9, 2022.
(60) Provisional application No. 63/159,324, filed on Mar. 10, 2021.
(60) Provisional application No. 63/166,899, filed on Mar. 26, 2021.
(60) Provisional application No. 63/187,853, filed on May 12, 2021.
(60) Provisional application No. 63/191,764, filed on May 21, 2021.

(51) Int. Cl. H04B 7/06; H04B 17/318

(52) U.S. Cl. CPC H04B 7/0626; H04B 17/328

(57) ABSTRACT

Methods and apparatuses for beam reporting for multi-transmission/reception points are provided. The method includes receiving a set of resources for beam measurements. The set of resources includes two portions, each of which corresponds to a transmission/reception point. The method includes receiving a request to measure perform a layer-1 reference signal received power measurement, and reporting one or more reporting groups in a channel state information reporting instance.

### CROSS-REFERENCE TO RELATED APPLICATION(S)

The present disclosure is a continuation application of International Application No. PCT/IB2022/052071, filed on Mar. 9, 2022, which claims the benefit of priorities to U.S. Provisional Patent Application No. 63/159,324, filed Mar. 10, 2021, U.S. Provisional Patent Application No. 63/166,899, filed Mar. 26, 2021, U.S. Provisional Patent Application No. 63/187,853, filed May 12, 2021, and U.S. Provisional Patent Application No. 63/191,764, filed May 21, 2021, all of which are incorporated herein by reference in their entireties.

### TECHNICAL FIELD

This application relates to the communications field, and more specifically, to a wireless communications system, method, and device.

### BACKGROUND

Rapid growth in computing technology is creating a greater demand for data communication. The increasing demand in turn drives further growth in communication technology, including beam communication or operations. New radio (NR) or 5th generation (5G) communication system supports reference signal received power (RSRP)-based and signal to interference noise ratio (SINR)-based beam measurement and reporting.

The NR/5G system supports Layer-1 (L1)-RS RP-based and L1-S INR based beam measurement and reporting. For the L1-RSRP-based beam reporting, a user equipment (UE) can be configured with up to 64 CSI-RS (Channel State Information Reference Signal) resources or SS/PBCH (Synchronization Signal/Physical Broadcast Channel) blocks for the L1-RSRP measurement. The UE can select up to 4 CSI-RS resources or SS/PBCH blocks from those configured resources and then report the indicators of those selected CSI-RS resources or SS/PBCH blocks and corresponding L1-RSRP measurement results to a base station (gNB).

The 3GPP Release 15 also supports group-based L1-RSRP beam report, in which a UE can be configured with a resource setting for channel measurement that contains a set of non-zero-power (NZP) CSI-RS resources or SS/PBCH blocks. More particularly, each NZP CSI-RS resource or SS/PBCH block is used to represent one gNB transmit beam. The UE is configured to measure the L1-RSRP of those NZP CSI-RS resources or SS/PBCH blocks. Then the UE can report two CRIs (CSI-RS resource indicator) or SSBRIs (SS/PBCH block resource indicator) for two selected NZP CSI-RS resources or SS/PBCH blocks which the UE is able to use a single spatial domain receive filter or multiple simultaneous spatial domain receive filters.

If the UE is configured in a group-based beam reporting mode (i.e., parameter “groupBasedBeamReporting” being set as “enabled”), the UE reports, in a single reporting instance, two different CRIs or SSBRIs for each report setting, where CSI-RS and/or SSB resources can be received simultaneously by the UE. For that two reported CRIs or SSBRIs, the UE uses differential L1-RSRP based reporting, where the largest measured value of the L1-RSRP is quantized to a 7-bit value and a differential L1-RSRP is quantized to a 4-bit value. More particularly, in a single beam reporting instance, the bitwidth for CRI, SSBRI, RSRP, and differential RSRP are determined according to the following Table 1-A:

TABLE 1-A
CRI, SSBRI, and RSRP

| Field | Bitwidth |
|---|---|
| CRI | ┌log₂ Kₛ^{CSI-RS}┐ |
| SSBRI | ┌log₂ Kₛ^{SSB}┐ |
| RSRP | 7 |
| Differential | 4 |
| RSRP | |

In the foregoing table, Kₛ^{CSI-RS} is the number of CSI-RS resources in the corresponding resource set, and Kₛ^{SSB} is the configured number of SS/PBCH blocks in the corresponding resource set for reporting “ssb-Index-RSRP.” Mapping orders of CSI fields of CRI/RSRP or SSBRI/RSRP are specified in Table 1-B below.

TABLE 1-B
Mapping orders of CSI fields of one report
for CRI/RSRP or SSBRI/RSRP reporting

| CSI report | |
|---|---|
| number | CSI fields |
| CSI report | CRI or SSBRI #1 as in Table 6.3.1.1.2-6, if |
| #n | reported |
| | CRI or SSBRI #2 as in Table 6.3.1.1.2-6, if |
| | reported |
| | CRI or SSBRI #3 as in Table 6.3.1.1.2-6, if |
| | reported |
| | CRI or SSBRI #4 as in Table 6.3.1.1.2-6, if |
| | reported |
| | RSRP #1 as in Table 6.3.1.1.2-6, if reported |
| | Differential RSRP #2 as in Table 6.3.1.1.2-6, if |
| | reported |
| | Differential RSRP #3 as in Table 6.3.1.1.2-6, if |
| | reported |
| | Differential RSRP #4 as in Table 6.3.1.1.2-6, if |
| | reported |

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1 is a schematic diagram of a wireless communication system in accordance with one or more implementations of the present disclosure.

FIG. 2 is a schematic block diagram of a terminal device in accordance with one or more implementations of the present disclosure.

FIG. 3 is a schematic diagram of a Media Access Control (MAC) Control Element (CE) in accordance with one or more implementations of the present disclosure.

FIG. 4 is a flowchart of a method in accordance with one or more implementations of the present disclosure.

### DETAILED DESCRIPTION

The current beam measurement and reporting methods, however, are not able to effectively support the transmission of multiple transmission/reception points (TRPs). For example, with current methodologies, the system cannot report two different transmission (Tx) beams that are associated with two different TRPs. Accordingly, the reporting is not useful for multi-TRP transmission scheduling. Also, the UE only reports one pair of beams, which imposes great limitations on the flexibility of multi-TRP transmission scheduling. Therefore, it is advantageous to have an improved system to address the foregoing needs.

The present disclosure is directed to beam measurement and reporting. The present methods include determining a bitwidth of reported CRI (i.e., CSI-RS Resource Indicator) or SSBRI (i.e., Synchronization Signal/Physical Broadcast Channel Resource Block Indicator) for a first mode of beam measurement reporting. The present disclosure also include reporting formats, including CSI (i.e., Channel State Information) reporting formats for the first mode of beam measurement reporting.

In some embodiments, a user equipment (UE) can be provided with “K” CSI-RS resources or SS/PBCH blocks for beam measurement and reporting. Among those resources, “K₁” CSI-RS resources or SS/PBCH blocks are associated with one transmission/reception point (TRP) and the other “K₂” CSI-RS resources or SS/PBCH blocks are associated with another TRP. The UE can be requested to measure L1-RSRP of those configured CSI-RS resources or SS/PBCH blocks and then report one or multiple reporting group in one CSI reporting instance.

In each reporting group, the UE can be requested to report the following information: (1) A first CRI (e.g., a CSI-RS resource indicator) or SSBRI (e.g., an SS/PBCH resource block indicator) which corresponds to one of those “K₁” CSI-RS resources or SS/PBCH blocks; (2) A second CRI or SSBRI which corresponds to one of those “K₂” CSI-RS resources or SS/PBCH blocks; (3) An L1-RSRP measurement of the CSI-RS resource or SS/PBCH block corresponding to the first CRI or SSBRI; and/or (4) An L1-RSRP measurement of the CSI-RS resource or SS/PBCH block corresponding to the second CRI or SSBRI.

In some embodiments, the UE can receive the first CRI or SSBRI and the second CRI or SSBRI with different spatial filers (e.g., simultaneously). In some embodiments, the UE can receive the first CRI or SSBRI and the second CRI or SSBRI with same spatial filers (e.g., simultaneously). In some embodiments, the UE can receive the first CRI or SSBRI and the second CRI or SSBRI with same or different spatial filers (e.g., simultaneously).

In some embodiments, the UE can be requested to report “N” reporting groups in one reporting instance. In some embodiments, the UE can be requested to report two CRIs or SSBRIs and corresponding L1-RSRP measurement.

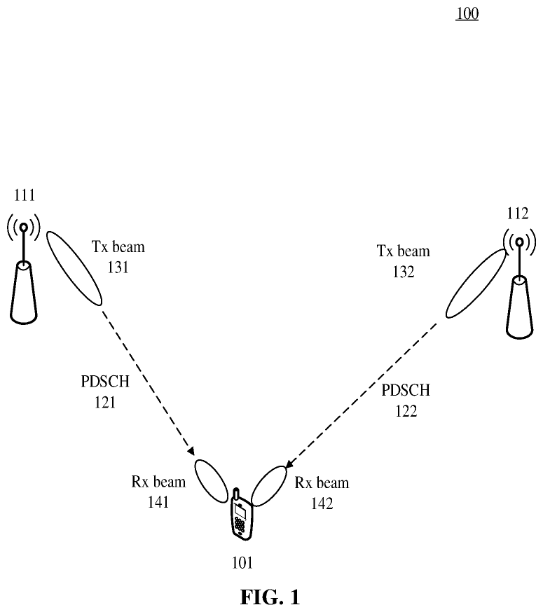

FIG. 1 illustrates a wireless communications system 100 for implementing the present technology. As shown in FIG. 1, the wireless communications system 100 can be a multi-TRP transmission system that includes one or more TRPs (e.g., a TRP 111 and a TRP 112) that constitute a network device (or base station). Examples of the network device include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device can include a relay station, an access point, an in-vehicle device, a wearable device, and the like. The network device can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IoT) network, a device-to-device (D2D) network, a next-generation network (e.g., a 5G network), a future evolved public land mobile network (Public Land Mobile Network, PLMN), or the like. A 5G system or network can be referred to as an NR system or network.

In FIG. 1, the wireless communications system 100 also includes a terminal device 101. The terminal device 101 can be an end-user device configured to facilitate wireless communication. The terminal device 101 can be configured to wirelessly connect to the network device (via, e.g., via a wireless channel 105) according to one or more corresponding communication protocols/standards. The terminal device 101 may be mobile or fixed. The terminal device 101 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 101 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IoT) device, a device used in a 5G network, a device used in a public land mobile network, or the like. For illustrative purposes, FIG. 1 illustrates only one network device and one terminal device 101 in the wireless communications system 100. However, in some instances, the wireless communications system 100 can include additional network devices and/or terminal devices.

The terminal device 101 can be configured to receive (e.g., PDSCH) transmission from both the TRP 111 and the TRP 112. For example, the TRP 111 can use transmission (Tx) beam 131 to transmit PDSCH 121 to the terminal device 101, while the TRP 112 can use Tx beam 132 to transmit PDSCH 122 to the terminal device 101. In some embodiments, the PDSCH 121 and PDSCH 122 can be fully, partially or not overlapped in time domain. When PDSCH 121 and PDSCH 122 are fully or partially overlapped in time domain, on the Orthogonal frequency-division multiplexing (OFDM) symbols where both PDSCH 121 and PDSCH 1222 are transmitted, the terminal device 101 is capable of receiving the signals transmitted by both the Tx beam 131 and the Tx beam 132.

Based on beam training, the terminal device 101 can be further configured to pair Rx beam 141 with Tx beam 131 and Rx beam 142 with Tx beam 132. Thus, to enable the terminal device 101 to receive signals transmitted by Tx beam 131 and Tx beam 132 on one same symbol, the terminal device 101 can be further configured to use Rx beam 141 and Rx beam 142 on the same symbol, i.e., simultaneously.

To facilitate the multi-TRP transmission the wireless communications system 100 can include the following functions. The terminal device 101 can be configured to measure multiple Tx beams from the TRP 111 and multiple Tx beams from the TRP 112. The terminal device 101 can be further configured to notify the system which Tx beam(s) of TRP 111 and Tx beam(s) of TRP 112 can be good candidates for downlink transmission. The wireless communications system 100 can choose the best Tx beam for TRP 112 and TRP 112 based on information (e.g., resource indicators, beam measurements) reported by the terminal device 101. Although only two TRPs have been described, the wireless communications system 100 can also support a third, fourth, or n-th TRP for beam measurement and reporting (where n is any predefined number) using similar configurations as those described above in relation to the TRP 111 or TRP 112.

The terminal device 101 can be provided with “K” CSI-RS resources or SS/PBCH blocks for beam measurement and reporting. For example, “K1” CSI-RS resources or SS/PBCH blocks (e.g., in a first list) are associated with one transmission/reception point (TRP) and the other “K2” CSI-RS resources or SS/PBCH blocks (e.g., in a second list) are associated with another TRP. The terminal device 101 can be requested to measure L1-RSRP of those configured CSI-RS resources or SS/PBCH blocks and then report one or multiple reporting group (e.g., a pair of 1st and 2nd CRI) in one CSI reporting instance.

The terminal device 101 can report, in each reporting group, the following information:
(1) A first CRI (e.g., a CSI-RS resource indicator) or SSBRI (e.g., an SS/PBCH resource block indicator) which corresponds to one of those “K1” CSI-RS resources or SS/PBCH blocks.
(2) A second CRI or SSBRI which corresponds to one of those “K2” CSI-RS resources or SS/PBCH blocks.
(3) An L1-RSRP measurement of the CSI-RS resource or SS/PBCH block corresponding to the first CRI or SSBRI.
(4) An L1-RSRP measurement of the CSI-RS resource or SS/PBCH block corresponding to the second CRI or SSBRI.

In some embodiments, the terminal device 101 can receive the first CRI or SSBRI and the second CRI or SSBRI with different spatial filers simultaneously. In some embodiments, the terminal device 101 can receive the first CRI or SSBRI and the second CRI or SSBRI with same spatial filers simultaneously. In some embodiments, the terminal device 101 can receive the first CRI or SSBRI and the second CRI or SSBRI with same or different spatial filers simultaneously.

In some embodiments, the terminal device 101 can report “N” (e.g., N=1, 2, 4, 3, 6, or 8) reporting groups in one reporting instance and in each reporting group. In some embodiments, the UE can be requested to report two CRIs or SSBRIs and corresponding L1-RSRP measurement.

There are multiple embodiments where the L1-RSRP measurement can be reported. In an embodiment, for example, the terminal device 101 can report the L1-RSRP measurement of every of those “2N” CRIs or SSBRIs.

In some embodiments, the terminal device 101 can report the L1-RSRP measurement of the reported CRI or SSBRI with the largest L1-RSRP measurement and report a differential L1-RSRP measurement of all the other reported CRIs or SSBRIs. In some embodiments, the differential L1-RSRP can be calculated with reference to the largest measured L1-RSRP value (which is part of the same L1-RSRP reporting instance).

In some embodiments, in each reporting group, the terminal device 101 can report the L1-RSRP measurement of the CRI or SSBRI with the largest measured L1-RSRP in each reporting group and report a differential L1-RSRP of the other CRI or SSBRI in that reporting group. The differential L1-RSRP can be computed with reference to the largest measurement L1-RSRP value (which is part of the same reporting group of the same L1-RSRP reporting instance).

In some embodiments, the terminal device 101 can report “N” reporting groups in one reporting instance. In such embodiments, in each reporting group, the terminal device 101 reports two CRIs or SSBRIs that can be received by the terminal device 101 simultaneously. In some cases, the terminal device 101 may not be able to find “N” pairs of CRIs or SSBRIs that can meet such a requirement. In such instances, the terminal device 101 can report less than “N” reporting groups.

For example, the terminal device 101 can report a parameter “Q” in the reporting instance to indicate the number of actually reported reporting groups. As another example, the terminal device 101 can use a special value in a CRI or SSBRI field to indicate that the corresponding reporting group is not valid.

The present disclosure also includes methods for determining the values of a reported CRI or SSBRI in reporting instances. For example, in some embodiments, the terminal device 101 can be provided with a first list of “K” CSI-RS resources or SS/PBCH blocks for beam measurement and reporting. Those “K” CSI-RS resources can be partitioned into two subsets: a first subset with “K₁” CSI-RS resources or SS/PBCH blocks and a second subset with “K₂” CSI-RS resources or SS/PBCH blocks (e.g., K=K₁+K₂). The first K₁ entries in the first list can be considered as the first subset and the rest K₂ entries in the first list can be considered as the second subset.

With this configuration, each report CRI “k” or SSBRI “k” (k≥0) correspond to configured “(k+1)-th” entry of the first list. In each reporting group, the reported first CRI or SSBRI and the reported second CRI and SSBRI correspond to different subsets of the first list.

In some embodiments, the terminal device 101 can report CRI or SSBRI as follows:
(1) In one reporting group, the first CRI k or SSBRI k (k≥0) correspond to configured (k+1)-th entry of the first subset.
(2) The second CRI l or SSBRI l (l≥0) correspond to configured “(l+1)-th” entry of the second subset.

The benefit of the foregoing approach includes that the number of bits used to represent each CRI or SSBRI can be reduced.

In some embodiments, the terminal device 101 can be provided with a first list of “K₁” CSI-RS resources or SS/PBCH blocks and a second list of “K₂” CSI-RS resources or SS/PBCH blocks. The terminal device 101 can be requested to report “N” reporting groups in one reporting instance and in each reporting group. The terminal device 101 can report a first CRI or SSBRI and a second CRI or SSBRI as follows: (1) the first CRI k or SSBRI k (k≥0) correspond to configured “(k+1)-th” entry of the first list; and (2) the second CRI l or SSBRI l (l≥0) correspond to configured “(l+1)-th” entry of the second list.

In another example, a CRI k or SSBRI k (k≥0) can correspond to configured “(k+1)-th” entry of the first list if “k<K₁” and correspond to configured “(k+1−K₁)-th” entry of the second list if “k≥K₁.”

In some embodiments, the terminal device 101 can be provided with “K” CSI-RS resources or SS/PBCH blocks for beam measurement and reporting. Among those resources, “K₁” CSI-RS resources or SS/PBCH blocks are associated with one TRP and the other “K₂” CSI-RS resources or SS/PBCH blocks are associated with another TRP.

Various embodiments are provided for determining the reporting instance format. In one reporting instance, the terminal device 101 can be requested to report “N” reporting group and in each reporting group. The terminal device 101 can be requested to report a first CRI or SSBRI and a second CRI or SSBRI and the information of corresponding measured L1-RSRP.

In some embodiments, the bitwidth for each reported CRI or SSBRI can be ┌log₂(K)┐. Mapping orders of CSI fields in one report can be shown in Table 2-A (e.g., “N=2” reporting groups in one reporting instance).

TABLE 2-A

| CSI report | |
|---|---|
| number | CSI fields |
| CSI report | CRI or SSBRI #1 |
| #n | CRI or SSBRI #2 |
| | CRI or SSBRI #3 |
| | CRI or SSBRI #4 |
| | RSRP #1 |
| | Differential RSRP #2 |
| | Differential RSRP #3 |
| | Differential RSRP #4 |

As shown in Table 2-A, in some embodiments, the reported CRI or SSBR #1 and #2 can belong to one same reporting group and the reported CRI or SSBRI #3 and #4 can belong to one same reporting group.

In some embodiments, the reported CRI or SSBR #1 and #3 can belong to one same reporting group and the reported CRI or SSBRI #2 and #4 can belong to one same reporting group.

In some embodiments, the bitwidth for one reported CRI or SSBRI in one reporting group can be ┌log₂(K₁)┐ if the reported CRI or SSBRI corresponds one entry in those K₁ CSI-RS resources or SS/PBCH blocks and is ┌log₂(K₂)┐, if the reported CRI or SSBRI corresponds one entry in those K₂ CSI-RS resources or SS/PBCH blocks. The mapping orders of CSI fields one report can be one or more of the following examples:
[1] As shown in Table 2-B, there are “N=2” reporting groups in one reporting instance. The CRI or SSBRI #1 and CRI or SSBRI #2 are in the same reporting group and the Flag #1 is used to indicate whether the CRI or SSBRI #1 correspond to one entry in those K₁ CSI-RS resources or SS/PBCH blocks or one entry in those K₂ CSI-RS resources or SS/PBCH blocks.
[2] The CRI or SSBRI #3 and CRI or SSBRI #4 are in the same reporting group and the Flag #3 is used to indicate whether the CRI or SSBRI #3 correspond to one entry in those K₁ CSI-RS resources or SS/PBCH blocks or one entry in those K₂ CSI-RS resources or SS/PBCH blocks.

TABLE 2-B

| CSI report | |
|---|---|
| number | CSI fields |
| CSI report | Flag#1 |
| #n | CRI or SSBRI #1 |
| | CRI or SSBRI #2 |
| | Flag#3 |
| | CRI or SSBRI #3 |
| | CRI or SSBRI #4 |
| | RSRP #1 |
| | Differential RSRP #2 |
| | Differential RSRP #3 |
| | Differential RSRP #4 |

In some embodiments, as shown in Table 2-C (“N=2” reporting groups in one reporting instance), the CRI or SSBRI #1 and CRI or SSBRI #3 can be in the same reporting group and the Flag #1 is used to indicate whether the CRI or SSBRI #1 correspond to one entry in those K₁ CSI-RS resources or SS/PBCH blocks or one entry in those K₂ CSI-RS resources or SS/PBCH blocks. The CRI or SSBRI #2 and CRI or SSBRI #4 can be in the same reporting group and the Flag #2 is used to indicate whether the CRI or SSBRI #2 correspond to one entry in those K₁ CSI-RS resources or SS/PBCH blocks or one entry in those K₂ CSI-RS resources or SS/PBCH blocks.

TABLE 2-C

| CSI report | |
|---|---|
| number | CSI fields |
| CSI report | Flag#1 |
| #n | CRI or SSBRI #1 |
| | Flag #2 |
| | CRI or SSBRI #2 |
| | CRI or SSBRI #3 |
| | CRI or SSBRI #4 |
| | RSRP #1 |
| | Differential RSRP #2 |
| | Differential RSRP #3 |
| | Differential RSRP #4 |

In some embodiments, as shown in Table 2-D (“N=2” reporting groups in one reporting instance), the CRI or SSBRI #1 and CRI or SSBRI #3 are in the same reporting group and the Flag #1 is used to indicate whether the CRI or SSBRI #1 correspond to one entry in those K₁ CSI-RS resources or SS/PBCH blocks or one entry in those K₂ CSI-RS resources or SS/PBCH blocks. The CRI or SSBRI #2 and CRI or SSBRI #1 shall correspond the CSI-RS resource or SS/PBCH blocks from the same subset. The K₁ CSI-RS resources or SS/PBCH blocks can be referred to as the first subset and the K₂ CSI-RS resources or SS/PBCH blocks can be referred to as the second subset.

Another example method of Table 2-D is the CRI or SSBRI #1 and CRI or SSBRI #2 are in the same reporting group and the CRI or SSBRI #3 and CRI or SSBRI #4 are in another reporting group. Flag #1 is used to indicate whether the CRI or SSBRI #1 correspond to one entry in the first subset or in the second subset. The CRI or SSBRI #1 and the CRI or SSBRI #3 correspond CSI-RS resources or SS/PBCH blocks in the same subset.

TABLE 2-D

| CSI report | |
|---|---|
| number | CSI fields |
| CSI report | Flag#1 [e.g., for indicating the highest CRI] |
| #n | CRI or SSBRI #1 |
| | CRI or SSBRI #2 |
| | CRI or SSBRI #3 |
| | CRI or SSBRI #4 |
| | RSRP #1 |
| | Differential RSRP #2 |
| | Differential RSRP #3 |
| | Differential RSRP #4 |

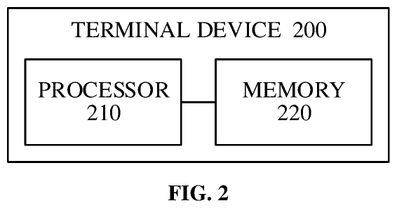

FIG. 2 is a schematic block diagram of a terminal device 200 (e.g., an example of the terminal device 101 of FIG. 1) in accordance with one or more implementations of the present disclosure. As shown in FIG. 2, the terminal device 200 includes a processing unit 210 (e.g., a DSP, a CPU, a GPU, etc.) and a memory 220. The processing unit 210 can be configured to implement instructions that correspond to the methods discussed herein and/or other aspects of the implementations described above. The processing unit 210 may also be coupled to a memory 220.

It should be understood that the processor in the implementations of this technology may be an integrated circuit chip and has a signal processing capability. During implementation, the steps in the foregoing method may be implemented by using an integrated logic circuit of hardware in the processor or an instruction in the form of software. The processor may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor may be a microprocessor, or the processor may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory, and the processor reads information in the memory and completes the steps in the foregoing methods in combination with the hardware thereof.

It may be understood that the memory 220 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type.

Panel Operation for a UE with Multiple Antenna Panels

In some embodiments, the terminal device 101 or the terminal device 200 can include multiple antenna panels. During a multi-beam operation, a portion of the antenna panels can be deactivated so as to reduce power consumption. The present disclosure include methods that can indicate reference signals (RS) corresponding to active panels for uplink transmission, so as to avoid beam misalignment.

In beam measurement and reporting, the terminal device 101 or the terminal device 200 can report the association between each CRI or SSBRI and a value of a parameter. In some embodiments, the terminal device can report the association between each CSI-RS resource or SS/PBCH block with the value of a parameter through an MAC CE (Media Access Control-Control Element). For example, the terminal device can report the association between each SRS resource set and the value of a parameter through the MAC CE. The terminal device can also report the status of each value of the parameter.

In some embodiments, the terminal device can report the relationship between the antenna panels (e.g., using a panel index to indicate a panel status, such as the number of the panels, transmission powers, etc.) and the CRI or SSBRI.

In some embodiment, a UE can use a parameter “X1” to identify a set of uplink transmission filter configurations. The parameter X1 can take multiple values, for example the value of X1 can be 0 or 1. Each value of the parameter X1 can correspond to a set of uplink transmission filter configuration.

In an UE capability reporting, the UE can be requested to report the UE capability of supporting the parameter X1. For example, the UE can report whether the UE support using the parameter X1 or not. For example, the UE can report how many values of parameter X1 the UE can support. For example, the UE can report supporting two values for parameter X1, the UE can report supporting three values for parameter X1 and the UE can report supporting four values of parameter X1.

In some embodiments, the UE can be requested to report the association between one CSI-RS resource or SS/PBCH block resource and one value of the parameter X1. The UE can be requested to report the association between one SRS resource set and one value of the parameter X1. The UE can be requested to report the status of one value of the parameter X1. For example, the UE can support the values of parameter X1 to be 0 or 1. The UE can report that the parameter X1 value 0 is active or inactive. The UE can report that the parameter X1 value 1 is active or inactive.

In some embodiments, the UE can be requested to report the association between a uplink TCI (Transmission Configuration Indicator) state or joint TCI state and one value of the parameter X1.

For example, in some embodiments, the UE can be configured with a set of “N” CSI-RS resources and/or SS/PBCH block resources. The UE can be requested to measure those CSI-RS resources and/or SS/PBCH block resources and the UE can be requested to report “K” CRI or SSBRI and corresponding L1-RSRP measurements. For each reported CRI or SSBRI, the UE can report a value of parameter “X1.” In one example, the UE can report “K=1” CRIs as follows:
[1] {CRI or SSBRI, the L1-RSRP measurement of this CRI/SSBRI, one value of parameter X1}. For example, the value of parameter X1 can be 0 or 1.
[2] In one example, for a reported CRI or SSBRI, the UE can report that it corresponds to more than one values of parameter X1. For example, the UE can report that a CRI corresponds to both values 0 and 1 of parameter X1.

In another example, the UE can be requested to report “K=2” CRIs or SSBRIs, then the UE reports:
[1] {CRI #1 or SSBRI #1, the L1-RSRP measurement of CRI #1 or SSBRI #1, one value of parameter X1 associated with CRI #1 or SSBRI #1} and
[2] {CRI #2 or SSBRI #2, the differential L1-RSRP measurement of CRI #2 or SSBRI #2 with reference to the L1-RSRP of CRI #1 or SSBRI #1, one value of parameter X1 associated with CRI #2 or SSBRI #2}.

In some embodiments, a UE can be configured with a set of “N” CSI-RS resources and/or SS/PBCH block resources. The UE can be requested to measure those CSI-RS resources and/or SS/PBCH block resources and the UE can be requested to report K CRI or SSBRI and corresponding L1-SINR measurements. For each reported CRI or SSBRI, the UE can also be requested to report a value of the parameter X1. In one example, the UE can be requested to report “K=1” CRIs, then the UE reports:
[1] {CRI or SSBRI, the L1-SINR measurement of this CRI/SSBRI, one value of parameter X1}. For example, the value of parameter X1 can be 0 or 1.

In another example, the UE can be requested to report “K=2” CRIs or SSBRIs, then the UE reports:
[1] {CRI #1 or SSBRI #1, the L1-SINR measurement of CRI #1 or SSBRI #1, one value of parameter X1 associated with CRI #1 or SSBRI #1} and
[2] {CRI #2 or SSBRI #2, the differential L1-SINR measurement of CRI #2 or SSBRI #2 with reference to the L1-SINR of CRI #1 or SSBRI #1, one value of parameter X1 associated with CRI #2 or SSBRI #2}.

In one method, a UE can be configured with a set of “N” CSI-RS resources and/or SS/PBCH block resources. The UE can be requested to measure those CSI-RS resources and/or SS/PBCH block resources and the UE can be requested to report one or more CRI or SSBRI and corresponding L1-RSRP (or L1-SINR) measurements. In one reporting instance, the UE can divide the reported CRIs or SSBRIs into multiple subsets and each subset correspond to one value of the parameter X1. For example, the UE can be requested to report “K=4” CRIs or SSBRIs and the UE reports them in two subsets in one reporting instance:
[1] In the first subset of one reporting instance, the UE reports {CRI #1 or SSBRI #1, the corresponding L1-RSRP (or L1-SINR) measurement} and {CRI #2 or SSBRI #2, the corresponding L1-RSRP (or L1-SINR) measurement}.
[2] In the second subset of one reporting instance, the UE reports {CRI #3 or SSBRI #3, the corresponding L1-RSRP (or L1-SINR) measurement} and {CRI #4 or SSBRI #4, the corresponding L1-RSRP (or L1-SINR) measurement}.

The CRIs or SSBRIs reported in the first subset are associated with one value of parameter X1 and the CRIs or SSBRIs reported in the second subset are associated with another value of parameter X1.

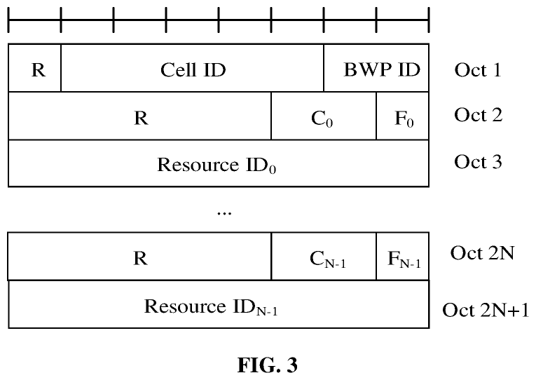

In some embodiments, a UE can be requested to report the association between CSI-RS resource or SS/PBCH block and the value of parameter X1 through a MAC CE signaling. An example of MAC CE for reporting that is shown in FIG. 3. As shown, an MAC CE can have a variable size and consists of the following fields:
[1] Cell ID: This field indicates the identity of the Serving Cell;
[2] BWP ID: This field indicates a DL BWP (downlink bandwidth part);
[3] Resource IDi: This field contains an identifier of the resource, for example an CSI-RS resource or a SS/PBCH block resource;
[4] Fi: This field indicates the type of a resource indicated by the Resource IDi field. For example it can indicate whether the resource is a CSI-RS resource or a SS/PBCH block;
[5] Ci: This field indicates a value of parameter X1 (which the resource reported in “Resource Idi” field corresponds to.

In some embodiments, a UE can be configured with one or more SRS resource sets. In each SRS resource set, the UE can be provided with one or more SRS resources. For one configured SRS resource set, the UE can be configured to report one value of parameter X1 that the SRS resource set is associated with. In one example, the UE can report that a first SRS resource set is associated with parameter X1 value=0, and the UE can report that a second SRS resource set is associated with parameter X1 value=1.

In one example, a base station or network can provide the association between an SRS resource set and one value of parameter X1 to the UE. For example, the network can provide configuration information to the UE that a first SRS resource set is associated with parameter X1 value=0, and a second SRS resource set is associated with parameter X1 value=1.

In some embodiments, a UE can report the status of one value of parameter X1 to the network. The UE can indicate the network that a first value of parameter X1 is active (activated) now. The UE can indicate the network that a first value of parameter X1 is inactive (deactivated) now. When a first value of parameter X1 is inactive, the UE does not expect the network to indicate any joint TCI state or uplink TCI state or any CSI-RS resource, SS/PBCH block or SRS resource associated with the first value of parameter X1 for uplink transmission. When a first value of parameter X1 is active, the network can indicate any joint TCI state or uplink TCI state or any CSI-RS resource, SS/PBCH block or SRS resource associated with the first value of parameter X1 to the UE for uplink transmission.

In some embodiments, the network can use DCI (downlink control information) signaling to indicate one joint TCI state or uplink TCI state to provide the uplink Tx spatial filter for uplink transmission for example PUSCH and PUCCH transmission. For example, the network can send one DCI carrying the indication of joint TCI state or uplink TCI state at slot n, the UE can be requested to apply the uplink Tx spatial filter indicated by the indicated TCI state starting from slot n+m. The UE can be configured with two application time length: t1 and t2. The first application time t1 is applied if the newly indicated joint TCI state or uplink TCI state and the current joint TCI state or uplink TCI state are associated with the same value of parameter X1 and the second application time t2 is applied if the newly indicated joint TCI state or uplink TCI state and the current joint TCI state or uplink TCI state are associated with the different values of parameter X1. Generally, the second application time t2 is longer than the first application time t1.

In one example, the UE is requested to apply a first joint TCI state (or a first uplink TCI state) on uplink transmission. At slot n, the UE receives a DCI indicating a second joint TCI state (or a second uplink TCI state) at slot n and the UE sends the ACK for that DCI at slot p. The UE shall apply the newly indicated the second joint TCI state (or the second uplink TCI state) on uplink transmission as follows:

If the first joint TCI state (or the first uplink TCI state) and the second joint TCI state (or the second uplink TCI state) are associated with one same value of parameter X1, the UE shall apply the newly TCI starting from the first slot that is t1 time after the UE sending the ACK.

If the first joint TCI state (or the first uplink TCI state) and the second joint TCI state (or the second uplink TCI state) are associated with different values of parameter X1, the UE shall apply the newly TCI starting from the first slot that is t2 time after the UE sending the ACK.

In some embodiments, the association between one value of parameter X1 and a joint TCI state (or a uplink TCI state) can be defined by one or more of the following methods:
[1] An association between a joint TCI state (or uplink TCI state) and a value of parameter X1 can be reported by the UE.
[2] An association between a joint TCI state (or uplink TCI state) and a value of parameter X1 can be provided by the network.

Through the RS of uplink Tx spatial filter contained in the TCI state: If the RS contained in a joint TCI state (a uplink TCI state) providing the information of uplink Tx spatial filter is associated with a first value of parameter X1, this joint TCI state (a uplink TCI state) is associated with the first value of parameter X1.

In some embodiments, a UE can report antenna panel related capability, such as: (1) the number of downlink Rx panel and the number of uplink Tx panel; (2) the number of panels used for both downlink Rx and uplink Tx, etc.; (3) the application time for switching panel or switching/activating the panel, etc.

In some embodiments, different application time can be applied for the TCI switch that switch the panel or not. The application time can also depend on if the targeted panel is activated or not.

In some embodiments, the UE can report the status of the panel. The UE can report the panel status for the activated TCI state. The base station (gNB) can determine the DL TCI state and/or UL TCI state, depending on the reported status of UE panel (e.g., DL Rx panel and/or UL Tx panel).

In some embodiments, a UE can be requested to report the UE capability information related with the UE panels. The UE can be requested to report one or more of the following information: the number of downlink receive panels, the number of uplink transmit panels, the number of panels that are used as both downlink receive panel and uplink transmit panel, the number of downlink receive panels that can be used simultaneously, the number of uplink transmit panels that can be used simultaneously, a minimal application time of TCI state for panel operation, etc.

In some embodiments, the UE can report a minimal application time for TCI state switch if the UE needs to switch DL Rx panel for DL TCI. The UE can report a minimal application time for TCI state switch if the UE needs to switch Rx beam but not switch DL Rx panel.

In some embodiments, the UE can report a minimal application time for UL TCI state switch if the UE needs to switch UL Tx panel for UL TCI. The UE can report a minimal application time for UL TCI state switch if the UE needs to switch UL Tx beam but not switch UL Tx panel.

In some embodiments, the UE can report different minimal application time for TCI state switch for the following two different cases:
Case 1: the indicated TCI state corresponds to a first panel and the first panel is active.
Case 2: the indicated TCI state corresponds to a second panel and the second panel is not activated. For this case, the time needed for activating the second panel shall be considered.

In some embodiments, the UE can report the number of SRS resources for beam sweeping for each particular uplink transmit panel. The UE can report the number of uplink transmit panels that can be used to transmit uplink signal simultaneously. The UE can report minimal application time for DL TCI indication. The UE can report minimal application time for UL TCI indication.

In some embodiments, a UE can be indicated with a first TCI state that provided QCL information for downlink PDCCH and PDSCH and/or uplink spatial filter information for uplink PUSCH and PUCCH. The UE can be indicated the first TCI state through a DCI format and the UE send a HARQ-ACK for the TCI state indication to the gNB. For the indicated TCI state, a base station (gNB) can configure K application time points. Starting from the indicated application time point, the UE starts to applied the QCL configuration included in the first TCI state on PDCCH/PDSCH reception and/or the uplink spatial filter information on the transmission of PUSCH and PUCCH. The UE can determine the application time point according to one or more of the followings:
[1] If the indicated TCI state and the current active TCI state correspond to the same panel, then the UE shall choose a first application time point and if the indicated TCI state and the current active TCI state correspond to different panel, then the UE shall choose a second application time point.
[2] If the panel corresponding to the indicated TCI state is active, then the UE shall choose a first application time point and if the panel corresponding to the indicated TCI state in not activated, then the UE shall choose a second application time point.
[3] If the indicated TCI state and the current active TCI state correspond to the same panel, then the UE shall choose a first application time point and if the indicated TCI state and the current active TCI state correspond to different panel and the panel corresponding to the indicated TCI state is active, then the UE shall choose a second application time point. If the indicated TCI state and the current active TCI state correspond to different panel and the panel corresponding to the indicated TCI state is not activated, then the UE shall choose a second application time point.

In some embodiments, a UE can report the status of one panel. The UE can report if one panel is activated or not. The UE can report that a first panel is activated for DL RX. The UE can report that a first panel is not activated. The UE can report that a first panel is activated for UL Tx. The UE can report that a first panel is activated for both UL Tx and DL Rx. The UE can report that a first panel is activated for DL Rx but not activated for UL Tx. The UE can report that a first panel is activated for UL Tx but not activated for DL Rx.

In one method, the UE can report the status of one DL panel through a MAC CE. The UE can report the status of one UL panel through a MAC CE. In one method, the gNB can activate M TCI states through MAC CE and the UE can report the status of panel corresponding to each activated TCI state. For an activated TCI state providing DL QCL configuration, the UE can report the status of DL panel corresponding to it. For an activated TCI state providing uplink spatial filter information, the UE can report the status of UL panel corresponding to it. Specially, for an activated joint TCI state or UL TCI state, the UE can report the status of UL panel that corresponds to the activated joint TCI state or UL TCI state. With the reported panel status information, the system can determine the TCI state application time accordingly.

Beam Reporting for Uplink Transmit Power

In some embodiments, a UE can report a 2-part CSI report. The first part in the CSI report includes the reported CRI/SSBRI and corresponding L1-RSRP or L1-SINR measurement, and the second part in the CSI report includes the information on MPE event related with each reported CRI or SSBRI.

In the 2nd part of the CSI report, the UE can report a P-MPR value for each reported CRI/SSBRI, a power backoff value for each reported CRI/SSBRI, and/or a virtual power headroom by assuming that CRI/SSBRI is used for uplink transmission. The 2nd part in the CSI report can be optional.

One bit field in the first part can indicate whether the 2nd part in the same CSI report instance exist or not. One bit field in the first part can indicate the size of the 2nd part in the same CSI report.

In one embodiment, a UE can be requested to report a 2-part beam reporting (or called 2-part CSI reporting). Each beam reporting instance can contain two parts: a first part (or can be called CSI part 1) and a second part (can be called CSI part 2). In the first part, the UE can report one or more CRIs/SSBRIs and the corresponding beam measurement, for example, L1-RSRP measurement or L1-SINR measurement. In the second part, the UE can report MPE-related information for one or more reported CRIs or SSBRIs.

The MPE-related information for a CRI or SSBRI can be one or more of the following:
[1] One indicator to indicate whether MPE event happens for that CRI or SSBRI if that CRI or SSBRI is used for uplink transmission, in other word, if the CSI-RS resource corresponding to that CRI or SS/PBCH block corresponding to that SSBRI is configured as source for UL TCI of uplink transmission.
[2] Reporting a value of P-MPR related with that CRI or SSBRI.
[3] Reporting a virtual PHR (power header room) value related with that CRI or SSBRI.
[4] An indicator to show whether one CRI or SSBRI is feasible for uplink transmission, i.e., to indicate the gNB that if that CSI or SSBRI can be configured as source for spatial Tx filter for uplink transmission.
[5] A uplink transmit power back off value corresponding to that CRI or SSBRI.

In some embodiments, a UE can be configured to report a two-part CSI report for beam reporting. In the first part of the CSI report (i.e., CSI part 1), the UE can report N (for example N=1, 2, 3 or 4) CRIs or SSBRIs. In CSI part 1, the UE can report the following:
[1] N (for example 1, 2, 3, or 4) CRIs or SSBRIs.
[2] The L1-RSRP measurement of CRI or SSBRI with the largest L1-RSRP measurement.
[3] The differential L1-RSRP measurement of other N−1 CRIs or SSBRIs with respect to the largest L1-RSRP in the same CSI report instance.
[4] One indicator to indicate whether the CSI part 2 exist or not in the CSI report instance. For example, this indicator can be one bit. This bit being 1 means the CSI part 2 exist while this bit being 0 means the CSI part 2 does not exist.

In the CSI part 2, the UE can report one or more of the following information:
[1] N indicators and each indicator is used to indicate whether one reported CRI or SSBRI is feasible to be configured as source for spatial Tx filter for uplink transmission.
[2] N indicators and each indicator is used to indicate if the MPE event happens for one reported CRI or SSBRI.
[3] N P-MPR values and each P-MPR value is for one reported CRI or SSBRI in the CSI part 1.
[4] N virtual PHR values and each virtual PHR values is for one reported CRI or SSBRI in the CSI part 1.
[5] N uplink transmit power back off values and each uplink transmit power back off value corresponding to one reported CRI or SSBRI.

In some embodiments, a UE can be configured to report a two-part CSI report for beam reporting. In the first part of the CSI report (i.e., CSI part 1), the UE can report N (for example N=1, 2, 3 or 4) CRIs or SSBRIs. In CSI part 1, the UE can report the following:
[1] N (for example 1, 2, 3, or 4) CRIs or SSBRIs.
[2] The L1-RSRP measurement of CRI or SSBRI with the largest L1-RSRP measurement.
[3] The differential L1-RSRP measurement of other N−1 CRIs or SSBRIs with respect to the largest L1-RSRP in the same CSI report instance.
[4] One indicator to indicate the information of the size of the CSI part 2. For example, if the indicator indicate the size of CSI part 2 is zero, then that means there is CSI part 2 in this CSI report. For example, the indicator can indicate the number of CRIs or SSBRIs that the CSI part 2 carries MPE information for. For example, the indicator can indicate that the CSI part 2 carriers MPE information for M CRIs/SSBRIs out of those N reported CRIs/SSBRIs in the CSI part 1. The value of M can be 0, 1, N and if the value of M is 0, that means there is no CSI part 2 in this CSI report instance.

Then in the CSI part 2, the UE can report one or more of the following information: (1) M sets of information of {one indicator to refer to the reported CRI or SSBRI in the CSI part 1, one P-MPR value corresponding to this CRI or SSBRI}; (2) M sets of information of {one indicator to refer to the reported CRI or SSBRI in the CSI part 1, one virtual PHR value corresponding to this CRI or SSBRI}; (3) M sets of information of {one indicator to refer to the reported CRI or SSBRI in the CSI part 1, one uplink transmit power back off value corresponding to this CRI or SSBRI}; (4) M sets of information of {one indicator to refer to the reported CRI or SSBRI in the CSI part 1, one indicator to indicate whether MPE event happens for this CRI or SSBRI}; (5) M sets of information of {one indicator to refer to the reported CRI or SSBRI in the CSI part 1, one indicator to indicate whether this CRI or SSBRI is feasible to be configured as source for spatial Tx filter for uplink transmission}.

In one embodiment, a UE can be requested to report a beam reporting (CSI report) and report the following information in one reporting instance: (1) N CRIs or SSBRIs (e.g., N can be 1, 2, 3 or 4); (2) the L1-RSRP (or L1-SINR) measurement for each reported CRI or SSBRI. For the CRI or SSBRI with largest L1-RSRP, the UE can report the L1-RSRP. For the other CRI or SSBRI in one reporting instance, the UE can report differential L1-RSRP (or differential L1-SINR) that is calculated with respect to the L1-RSRP reported in the same reporting instance.

For each reported CRI or SSBRI, the UE can report one indicator to indicate: [1] whether this CRI or SSBRI is feasible to be configured as source for spatial Tx filter for uplink transmission (for example PUSCH, PUCCH or SRS); [2] whether MPE event happens for this CRI or SSBRI; [3] whether the value of P-MPR related with this CRI or SSBRI is above some threshold; [4] whether the power back off value related with this CRI or SSBRI is above some threshold; [5] one MPE value corresponding to this CRI or SSBRI; [6] one P-MPR value corresponding to this CRI or SSBRI; [7] one power back off value corresponding to this CRI or SSBRI; [8] one virtual PHR value corresponding to this CRI or SSBRI.

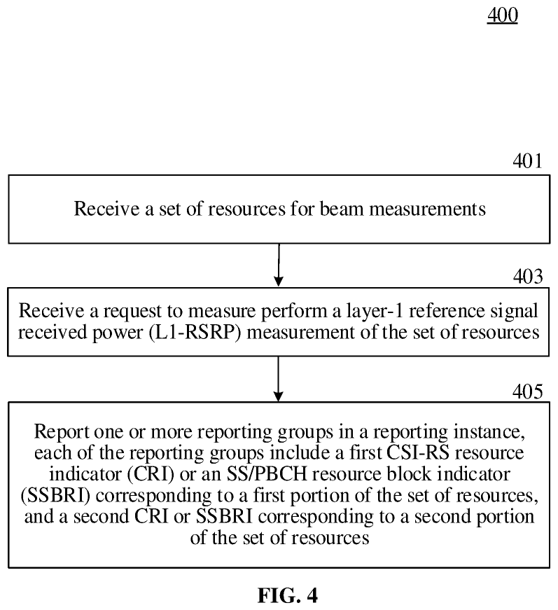

FIG. 4 is a flowchart of a method 400 in accordance with one or more implementations of the present disclosure. The method 400 can be implemented by a wireless communications system (e.g., the wireless communications system 100) that includes a terminal device or UE (e.g., the terminal device 101) and a network device or gNB (e.g., the network device described above in relation to FIG. 1) that includes one or more TRPs (e.g., the TRP 111 and TRP 112). The method 400 is for determining and reporting beam measurements of multiple TRPs.

At block 401, an UE receives a set of resources for beam measurements. In some embodiments, the set of resources can include Channel State Information Reference Signal (CSI-RS) resources or Synchronization Signal/Physical Broadcast Channel (SS/PBCH) blocks. A first portion of the set of resources is associated with a first transmission/reception point (TRP), and a second portion of the set of resources is associated with a second TRP.

At block 403, the UE receives a request to measure perform a layer-1 reference signal received power (L1-RSRP) measurement of the set of resources. The UE can then perform the L1-RSRP measurement. Once complete, at block 405, the UE reports one or more reporting groups in a CSI reporting instance. Each of the one or more reporting groups includes: (1) a first CSI-RS resource indicator (CRI) or an SS/PBCH resource block indicator (SSBRI) corresponding to the first portion of the set of resources; and (2) a second CRI or SSBRI corresponding to the second portion of the set of resources.

In some embodiments, each of the one or more reporting groups further includes (i) an L1-RSRP measurement of the CSI-RS resource or SS/PBCH block corresponding to the first CRI or SSBRI; and (ii) an L1-RSRP measurement of the CSI-RS resource or SS/PBCH block corresponding to the second CRI or SSBRI.

In some embodiments, for example, the set of resources includes K CSI-RS resources or SS/PBCH blocks. The first portion of the set of resources includes K1 CSI-RS resources or SS/PBCH blocks, and the second portion of the set of resources includes K2 CSI-RS resources or SS/PBCH blocks. K, K1, and K2 are integers, and K equals to K1 plus K2.

In some embodiments, the method 400 further comprises receiving, at the UE, the first CRI or SSBRI and the second CRI or SSBRI with different spatial filers (e.g., simultaneously). In some embodiments, the method 400 further comprises receiving, at the UE, the first CRI or SSBRI and the second CRI or SSBRI with the same spatial filer (e.g., simultaneously).

In some embodiments, the one or more reporting groups include N reporting groups, and wherein N equals to 1, 2, 4, 3, 6, or 8. For example, the one or more reporting groups includes two CRIs or SSBRIs and corresponding L1-RSRP measurements of the two CRIs or SSBRIs.

In some embodiments, the L1-RSRP measurement of the set of resources can be reported once every two resources in the set of resources. In some embodiments, the L1-RSRP measurement of the set of resources can be reported with a largest L1-RSRP measurement and a differential L1-RSRP measurement (which can be calculated based on the largest L1-RSRP measurement).

In some embodiments, the method 400 further comprises reporting a flag indicating that a first resource of the first portion of the set of resources and a second resource of the second portion of the set of resources belong to a subset. Embodiments of the flag can be found, for example, in the descriptions with reference to Table 2D.

In some embodiments, the UE includes multiple antenna panels. In such embodiments, the method 400 further comprises reporting a parameter (e.g., parameter X1 discussed above) indicating a relationship between the first CRI or SSBRI and an antenna panel of the multiple antenna panels.

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification do not necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the disclosure is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the disclosure are presented below in certain claim forms, the applicant contemplates the various aspects of the disclosure in any number of claim forms. Accordingly, the applicant reserves the right to pursue additional claims after filing this application to pursue such additional claim forms, in either this application or in a continuing application.

1. A method for beam measurement, comprising:
receiving, by a user equipment (UE) from a base station, a set of resources for beam measurements, wherein the set of resources includes Channel State Information Reference Signal (CSI-RS) resources or Synchronization Signal/Physical Broadcast Channel (SS/PBCH) blocks, wherein a first portion of the set of resources is associated with a first transmission/reception point (TRP), and wherein a second portion of the set of resources is associated with a second TRP;
receiving, by the UE from the base station, a request to measure perform a layer-1 reference signal received power (L1-RSRP) measurement of the set of resources; and
reporting, by the UE to the base station, one or more reporting groups in a CSI reporting instance, wherein each of the one or more reporting groups includes:
a first CSI-RS resource indicator (CRI) or an SS/PBCH resource block indicator (SSBRI) corresponding to the first portion of the set of resources; and
a second CRI or SSBRI corresponding to the second portion of the set of resources.

2. The method of claim 1, wherein each of the one or more reporting groups further includes an L1-RSRP measurement of the CSI-RS resource or SS/PBCH block corresponding to the first CRI or SSBRI.

3. The method of claim 2, wherein each of the one or more reporting groups further includes an L1-RSRP measurement of the CSI-RS resource or SS/PBCH block corresponding to the second CRI or SSBRI.

4. The method of claim 1, wherein the set of resources includes K CSI-RS resources or SS/PBCH blocks,
wherein the first portion of the set of resources includes K1 CSI-RS resources or SS/PBCH blocks,
wherein the second portion of the set of resources includes K2 CSI-RS resources or SS/PBCH blocks; and
wherein K, K1, and K2 are integers, and wherein K equals to K1 plus K2.

5. The method of claim 1, further comprising:
receiving, by the UE, the first CRI or SSBRI and the second CRI or SSBRI with different spatial filers.

6. The method of claim 5, further comprising:
receiving, by the UE, the first CRI or SSBRI and the second CRI or SSBRI with different spatial filers simultaneously.

7. The method of claim 1, further comprising:
receiving, by the UE, the first CRI or SSBRI and the second CRI or SSBRI with a same spatial filer.

8. The method of claim 7, further comprising:
receiving, by the UE, the first CRI or SSBRI and the second CRI or SSBRI with the same spatial filer simultaneously.

9. The method of claim 1, wherein the one or more reporting groups include N reporting groups, and wherein N equals to 1, 2, 4, 3, 6, or 8.

10. The method of claim 1, wherein the one or more reporting groups includes two CRIs or SSBRIs and corresponding L1-RSRP measurements of the two CRIs or SSBRIs.

11. The method of claim 1, wherein the L1-RSRP measurement of the set of resources is reported once every two resources in the set of resources.

12. The method of claim 1, wherein the L1-RSRP measurement of the set of resources is reported with a largest L1-RSRP measurement and a differential L1-RSRP measurement.

13. The method of claim 1, wherein the differential L1-RSRP measurement is calculated based on the largest L1-RSRP measurement.

14. An apparatus, comprising:
a memory;
a processor coupled to the memory and configured to:
receive a set of resources for beam measurements, wherein the set of resources includes Channel State Information Reference Signal (CSI-RS) resources or Synchronization Signal/Physical Broadcast Channel (SS/PBCH) blocks, wherein a first portion of the set of resources is associated with a first transmission/reception point (TRP), and wherein a second portion of the set of resources is associated with a second TRP;
receive a request to measure perform a layer-1 reference signal received power (L1-RSRP) measurement of the set of resources; and
report one or more reporting groups in a CSI reporting instance,
wherein each of the one or more reporting groups includes:
a first CSI-RS resource indicator (CRI) or an SS/PBCH resource block indicator (SSBRI) corresponding to the first portion of the set of resources; and
a second CRI or SSBRI corresponding to the second portion of the set of resources.

15. The apparatus of claim 14, wherein
each of the one or more reporting groups further includes an L1-RSRP measurement of the CSI-RS resource or SS/PBCH block corresponding to the first CRI or SSBRI.

16. The apparatus of claim 15, wherein
each of the one or more reporting groups further includes an L1-RSRP measurement of the CSI-RS resource or SS/PBCH block corresponding to the second CRI or SSBRI.

17. The apparatus of claim 14, wherein the processor is further configured to receive the first CRI or SSBRI and the second CRI or SSBRI with different spatial filers.

18. The apparatus of claim 17, wherein the processor is further configured to receive the first CRI or SSBRI and the second CRI or SSBRI with different spatial filers simultaneously.

19. The apparatus of claim 14, wherein the one or more reporting groups include N reporting groups, and wherein N equals to 1, 2, 4, 3, 6, or 8.

20. The apparatus of claim 14, wherein the one or more reporting groups includes two CRIs or SSBRIs and corresponding L1-RSRP measurements of the two CRIs or SSBRIs.
